(19) United States
(12) Patent Application Publication
(10) Pub. No.: US 2017/0371916 A1
(43) Pub. Date: Dec. 28, 2017

(54) DATABASE MANAGEMENT DEVICE, DATABASE MANAGEMENT METHOD, AND STORAGE MEDIUM

(71) Applicant: Kabushiki Kaisha Toshiba, Minato-ku (JP)

(72) Inventors: Makoto SHIMAMURA, Kawasaki (JP); Mototaka KANEMATSU, Yokohama (JP)

(73) Assignee: Kabushiki Kaisha Toshiba, Minato-ku (JP)

(21) Appl. No.: 15/622,717

(22) Filed: Jun. 14, 2017

(30) Foreign Application Priority Data
Jun. 27, 2016 (JP) 2016-126977

(51) Int. Cl. G06F 17/30; G06F 9/46

(52) U.S. Cl. CPC G06F 17/30371; G06F 9/466; G06F 17/30377

(57) ABSTRACT

A database management device, a database management method, and a storage medium capable of improving convenience are provided. A first write manager of a database management device writes data for which a write instruction has been issued from a client to a first storage area of a storage unit. A second write manager writes WAL data corresponding to the write instruction from the client to any address in a second storage area of the storage unit. A determiner determines whether or not to write the WAL data to the second storage area for each transaction process. A transaction manager causes the first write manager to write the data and causes the second write manager to write the WAL data if the determiner determines to write the WAL data and causes the first write manager to write the data if the determiner determines not to write the WAL data.

### CROSS-REFERENCE TO RELATED APPLICATION

This application is based upon and claims the benefit of priority from Japanese Patent Application No. 2016-126977, filed Jun. 27, 2016; the entire contents of which are incorporated herein by reference.

### FIELD

Embodiments of the present invention relate to a database management device, a database management method, and a storage medium.

### BACKGROUND

In a process of writing data to a database, a write process called write ahead logging (WAL) is performed. The WAL process is a process of writing updated content to a WAL file before data is written to a table on a disk or an index file. Thereby, if a database system has been down, data can be restored on the basis of the WAL file. In conventional technology, determination of whether or not the WAL process is performed is done in units of databases or units of tables, and convenience is not sufficient.

### BRIEF DESCRIPTION OF THE DRAWINGS

FIG. 1 is a diagram illustrating an example of a functional configuration of a database management device in a first embodiment.

FIG. 2 is a diagram illustrating an example of a hardware configuration of the database management device in the first embodiment.

FIG. 3 is a diagram illustrating an example in which data is written using the WAL mode.

FIG. 4 is a diagram illustrating a state of data restoration using WAL data.

FIG. 5 is a flowchart illustrating an example of a WAL mode switching process in the first embodiment.

FIG. 6 is a flowchart illustrating an example of a transaction start process in the first embodiment.

FIG. 7 is a flowchart illustrating an example of a process of writing WAL data in the first embodiment.

FIG. 8 is a flowchart illustrating an example of a write process on a table file in the first embodiment.

FIG. 9 is a flowchart illustrating an example of a restoration process in the first embodiment.

FIG. 10 is a diagram illustrating a first example of a write process in the first embodiment.

FIG. 11 is a diagram illustrating a second example of a write process in the first embodiment.

FIG. 12 is a diagram illustrating a flow of a process according to a service start timing.

FIG. 13 is a diagram illustrating an example of a functional configuration of a database management device in a second embodiment.

FIGS. 14A and 14B are diagrams illustrating an example of a WAL use table provided in a transaction manager 32.

FIG. 15 is a flowchart illustrating an example of a WAL mode switching process in the second embodiment.

FIG. 16 is a flowchart illustrating an example of a process of writing WAL data in the second embodiment.

FIG. 17 is a diagram illustrating a first example of a write process in the second embodiment.

FIG. 18 is a diagram illustrating a second example of the write process in the second embodiment.

### DETAILED DESCRIPTION

An objective of the present invention is to provide a database management device, a database management method, and a storage medium capable of improving convenience.

A database management device of an embodiment includes a first write manager, a second write manager, a determiner, and a transaction manager. The first write manager writes data for which a write instruction has been issued from a client to an address corresponding to a logical address indicated by the client in a first storage area of a storage unit. The second write manager writes WAL data corresponding to the write instruction from the client to any address in a second storage area of the storage unit. The determiner determines whether or not to write the WAL data to the second storage area for each transaction process corresponding to the write instruction on the basis of information indicated from the client. The transaction manager causes the first write manager to write the data and causes the second write manager to write the WAL data if the determiner determines to write the WAL data, and causes the first write manager to write the data if the determiner determines not to write the WAL data, on the basis of the instruction from the client.

Hereinafter, a database management device, a database management method, and a storage medium according to embodiments will be described with reference to the drawings.

### First Embodiment

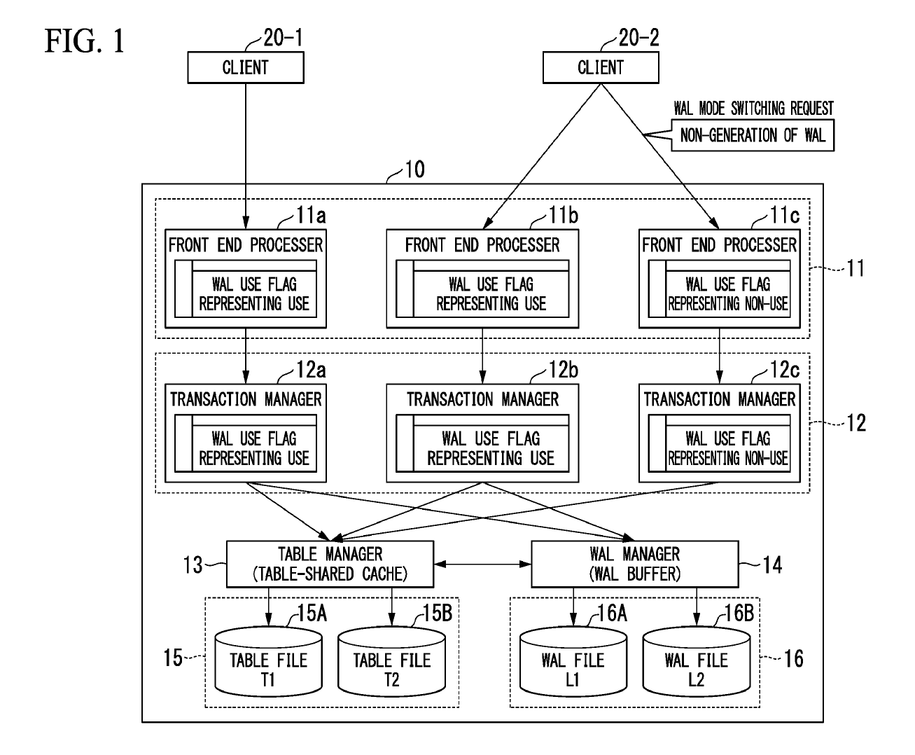

FIG. 1 is a diagram illustrating an example of a functional configuration of a database management device in the first embodiment. A database management device 10 illustrated in FIG. 1 includes a front end processor (determiner) 11, a transaction manager 12, a table manager (first write manager) 13, a WAL manager (second write manager) 14, a table file (first storage area) 15, and a WAL file (second storage area) 16. Some or all of these functional units may be realized by hardware such as large scale integration (LSI), an application specific integrated circuit (ASIC), and a field-programmable gate array (FPGA). Also, the database management device 10 has, for example, a function of a database management system (DBMS) or the like. Also, the table manager 13 and the WAL manager 14 have volatile memories. The table file 15 and the WAL file 16 have nonvolatile memories.

Two clients (clients 20-1 and 20-2) are shown as clients 20 using the database management device 10 in the example of FIG. 1, but the number of clients is not limited thereto. The client 20 may be an information processing device that is used by a user of the database management device 10, or may be a device that transmits various commands to the database management device 10 on the basis of a command or the like received from another device. Also, the client 20 may be a device that generates various commands on the basis of the results of internal information processing and transmits the commands to the database management device 10.

The client 20 transmits a write command for instructing the database management device 10 to write data, a read command for instructing the database management device 10 to read data, a delete command for instructing the database management device 10 to delete data, and the like to the front end processor 11. Also, the client 20 transmits a switching request for switching whether or not to write data to the WAL file 16 to the front end processor 11. Also, the database management device 10 and the client 20 are connected in a state in which data can be transmitted and received by a communication network represented by, for example, the Internet, a local area network (LAN), or the like. The communication network may be a wired network, a wireless network, or a combination thereof.

On the basis of an instruction transmitted from the client 20, the front end processor 11 generates a transaction manager 12 that executes and manages the transaction process, and determines whether or not switching of the WAL mode (write mode) to be executed for each transaction process is possible. Here, the “transaction process” is a process of executing a plurality of write commands received from the client 20 (for example, a command indicated to execute a data write process) as a series of processes. Also, the “series of processes” is a set of processes. In the “series of processes,” information including a plurality of write commands may be collectively received. The “series of processes” may be executed by receiving a plurality of write commands to which information indicating the series of processes (for example, transaction identification information) is commonly attached. Also, the transaction in the first embodiment is, for example, a transaction in which operation commands for databases (for example, the table file 15 and the WAL file 16 illustrated in FIG. 1, etc.) are combined so that atomicity, consistency, isolation, and durability (ACID) properties are provided. Also, the generation by the transaction manager 12 refers to activation of a module or the like that executes a process, for example, for each transaction.

Also, the front end processor 11 manages a WAL use flag for each transaction process indicated from the client 20 (the clients 20-1 and 20-2 in the example of FIG. 1). For example, the front end processor 11 receives a WAL mode switching request from the client 20. The WAL mode switching request is information indicating whether or not to write WAL data to the WAL file 16 for each transaction process on the basis of, for example, information indicated from the client 20. The front end processor 11 causes the transaction manager 12 to execute a write process using WAL if a request which uses WAL has been received, and causes the transaction manager 12 to execute the write process without using WAL if a request which does not use WAL has been received.

For example, the database management device 10 illustrated in FIG. 1 may be set so that the write process using WAL is executed for all transactions as an initial setting when there is no WAL mode switching request from the client 20. If a transaction process which does not use WAL is executed, the client 20 transmits a WAL mode switching request to the front end processor 11. Thereby, if the switching request has been received, the front end processor 11 switches the WAL use flag to “representing non-use” and instructs the transaction manager 12 to execute the corresponding write process.

Also, the above-described initial setting is not limited thereto, and the initial setting may be made to perform the write process, for example, without using WAL. Also, the front end processor 11 may automatically perform control for switching the WAL use flag to the original “representing use” after the corresponding transaction process is executed by the transaction manager 12 or may make a setting in which the WAL use flag is switched to “representing non-use.” Also, the WAL use flag is not limited to the information of “representing use/representing non-use” in the WAL mode, but may be identification information such as “TRUE/FALSE” or “1/0.”

Also, the front end processor 11 determines whether or not to permit the switching request according to whether or not the transaction is already being executed in response to the switching request received from the client 20. The front end processor 11 outputs information about possibility of switching based on the determination result to the client 20.

Also, the front end processor 11 may be generated for each execution instruction of object processing from the client 20. The generation of the front end processor 11 is, for example, activation of a module that executes a process in the front end processor 11. In this case, the front end processor 11 may stop the activated module after the activated module completes the above-described various processes.

In FIG. 1, an example in which the client 20-1 issues an instruction for executing one-object processing and the client 20-2 issues an instruction for executing two-object processing is illustrated. In this case, as illustrated in FIG. 1, three front end processors 11a to 11c are generated and manage the presence or absence of use of the WAL mode for each transaction. Also, the front end processor 11 sets information about any of “representing use” or “representing non-use” as the WAL use flag, and outputs the information to the target transaction manager 12.

The transaction manager 12 generates the transaction manager 12 for each transaction indicated from the client 20-1 or 20-2 according to an instruction from the front end processor 11. Also, the generated transaction manager 12 executes the corresponding transaction under each set write condition. In the example of FIG. 1, three transaction managers 12a to 12c are generated. The transaction managers 12a to 12c may be activated, for example, as modules. In this case, after the execution of the transaction process, the modules may be stopped.

Also, the transaction manager 12 stores processing result data (for example, data for which a write instruction has been issued) or WAL data in the storage unit (the table file 15 or the WAL file 16). The “data for which the write instruction has been issued” is data or the like which is updated by, for example, addition, modification, deletion, or the like of data. The “WAL data” is information for performing restoration up to data immediately before a malfunction, for example, when the system of the database management device 10 has been down, and includes, for example, log information about data for which the write instruction has been issued or process execution.

For example, when the WAL use flag obtained from the front end processor 11 is “representing use,” the transaction manager 12 outputs the processing result data to the table manager 13 and outputs the WAL data to the WAL manager 14. When the WAL use flag obtained from the front end processor 11 is “representing non-use,” the transaction manager 12 outputs data of processed data to the table manager 13.

The table manager 13 writes data for which a write instruction has been issued from the client 20 to an address corresponding to a logical address indicated by the client 20 in the table file 15. The table manager 13 includes, for example, a table-shared cache memory. The table manager 13 temporarily stores data obtained from the transaction manager 12, and repeatedly updates the table file 15 using the stored data for each checkpoint (Tcp). Also, the checkpoint may be, for example, a period based on time or may be a timing at which the amount of written data has exceeded a threshold value. In the transaction using WAL, the checkpoint is a point serving as a starting point for storing difference information from the table file 15 in the WAL file 16. When updating of the table file 15 is completed at the checkpoint, the data stored in the WAL file 16 may be deleted or not deleted.

The WAL manager 14 writes the WAL data corresponding to the write instruction from the client 20 to any address in the WAL file 16. The WAL manager 14 includes, for example, a buffer (WAL buffer) for temporarily storing WAL data. The WAL manager 14 stores the WAL data in the WAL file 16 at, for example, a timing at which data has been transmitted from the transaction manager 12.

Here, the above-described table manager 13 and the WAL manager 14 execute a data restoration process if the system has been down due to the occurrence of an error such as data crash or power failure, for example, when data is written. For example, the WAL manager 14 outputs the data and the like stored in the WAL file 16 to the table manager 13 in response to a request from the table manager 13. The table manager 13 restores the data on the basis of the WAL data obtained from the WAL manager 14 and stores the data in the table file 15. Thereby, it is possible to perform restoration up to data immediately before the malfunction of the system written to the WAL file 16.

The table file 15 and the WAL file 16 are examples of databases. The database is, for example, a collection of characters, numerical values, images, videos, and other information, and is systematically structured so that such information can be retrieved. The table file 15 and the WAL file 16 may be integrally formed as a storage unit, or may be provided as storage units separate from the database management device 10 like a cloud database.

The table file 15 reads and writes data. The table file 15 includes one or more table files. In the example of FIG. 1, two table files T1 15A and T2 15B are provided. Each table file is a database of a random access scheme managed by a logical address and a physical address on a memory. The table file 15 allocates address information of a logical address to data sent from the transaction manager 12 and stores data in a memory space of a physical address corresponding to the address information. Also, if a data read command has been received, the table file 15 retrieves a storage position of data from the logical address, and acquires data stored at a destination of the extracted address information. Because the table file 15 is used in a random access scheme, it is possible to quickly read data.

The WAL file 16 is a sequential access type database. The WAL file 16 includes one or more WAL files. In the example of FIG. 1, two WAL files L1 16A and L2 16B are provided. The WAL file 16 sequentially writes the WAL data sent from the transaction manager 12. “Sequentially writing” means sequentially writing data in the order of a physical address of the WAL file 16. Also, the data stored in the WAL file 16 may be deleted or not deleted after completion of writing to the table file 15 at the aforementioned checkpoint timing or after the passage of a predetermined time from the completion of writing.

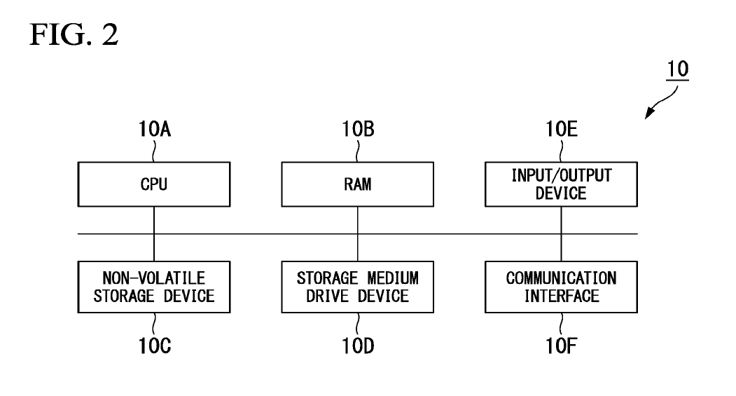

FIG. 2 is a diagram illustrating an example of a hardware configuration of the database management device in the first embodiment. The database management device 10 includes, for example, a central processing unit (CPU) 10A, a random access memory (RAM) 10B, a nonvolatile storage device 10C, a storage medium drive device 10D, an input/output device 10E, and a communication interface 10F. The database management device 10 may be provided with a processor in any form instead of the CPU 10A, or some of the constituent elements illustrated in FIG. 2 may be omitted.

The CPU 10A performs various processes described below by developing and executing a program stored in the nonvolatile storage device 10C or stored in a portable storage medium attached to the storage medium drive device 10D in the RAM 10B. Also, the database management device 10 may be provided with another type of processor instead of the CPU. The RAM 10B is an example of a volatile memory and is used as a working area by the CPU 10A. The nonvolatile storage device 10C is, for example, a hard disk drive (HDD), a flash memory, a read only memory (ROM), or the like. A portable storage medium such as a digital versatile disc (DVD), a compact disc (CD), or an SD card is mounted on the storage medium drive device 10D. The input/output device 10E includes, for example, a keyboard, a mouse, a touch panel, a display device, and the like. The communication interface 10F functions as an interface when the database management device 10 communicates with another device via the communication network. By causing the computer of the database management device 10 to cooperate with hardware as illustrated in FIG. 2 and software including a program and the like, various processes in the present embodiment can be realized.

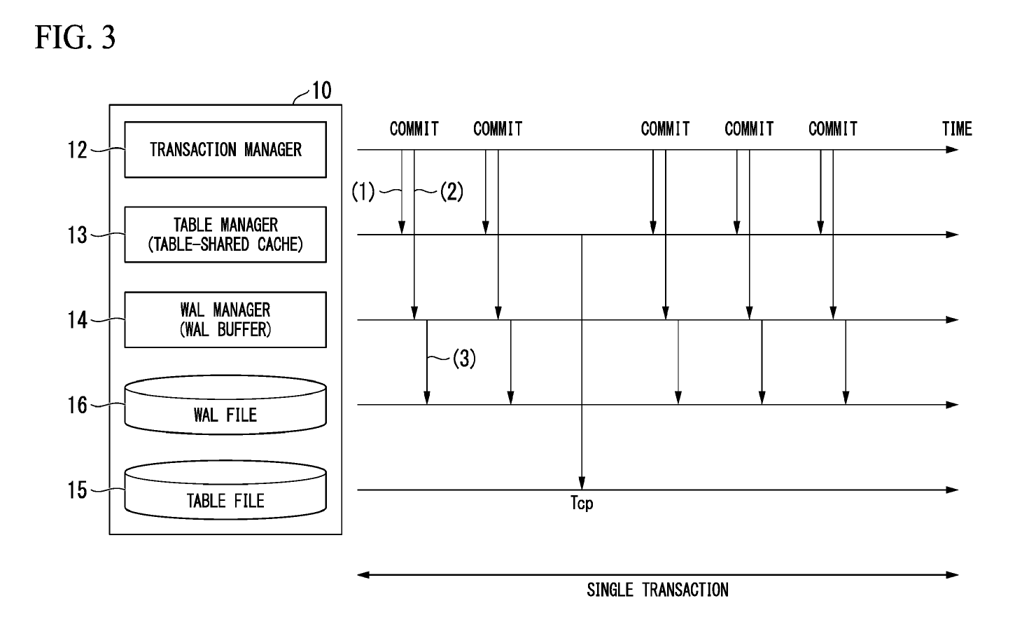

FIG. 3 is a diagram illustrating an example in which data is written using the WAL mode. In the example of FIG. 3, the transaction manager 12, the table manager 13, the WAL manager 14, the table file 15, and the WAL file 16 in the above-described database management device 10 are shown. Also, in the example of FIG. 3, a flow of data update based on the passage of time is shown in the transaction process including a plurality of write requests.

In the process of FIG. 3, a process in which the transaction manager 12 writes data to the table manager 13 ((1) illustrated in FIG. 3), a process in which the transaction manager 12 writes WAL data to the WAL manager 14 ((2) illustrated in FIG. 3), and a process in which the WAL manager 14 writes data written to the WAL buffer according to the above-described process (2) to the WAL file 16 are executed as a series of processes according to write requests. Completion of the write process based on the above-described plurality of write requests is referred to as “COMMIT.”

Also, in the data update using the WAL mode, as illustrated in FIG. 3, a plurality of transaction processes are executed with the passage of time and a process in which data stored in a table-shared cache of the table manager 13 is written to the table file 15 is executed at checkpoints provided at regular or arbitrary time intervals. That is, in the WAL mode, the transaction manager 12 periodically writes data to the WAL file 16, updates the table file 15 when the checkpoint is reached, and deletes data of the WAL file 16.

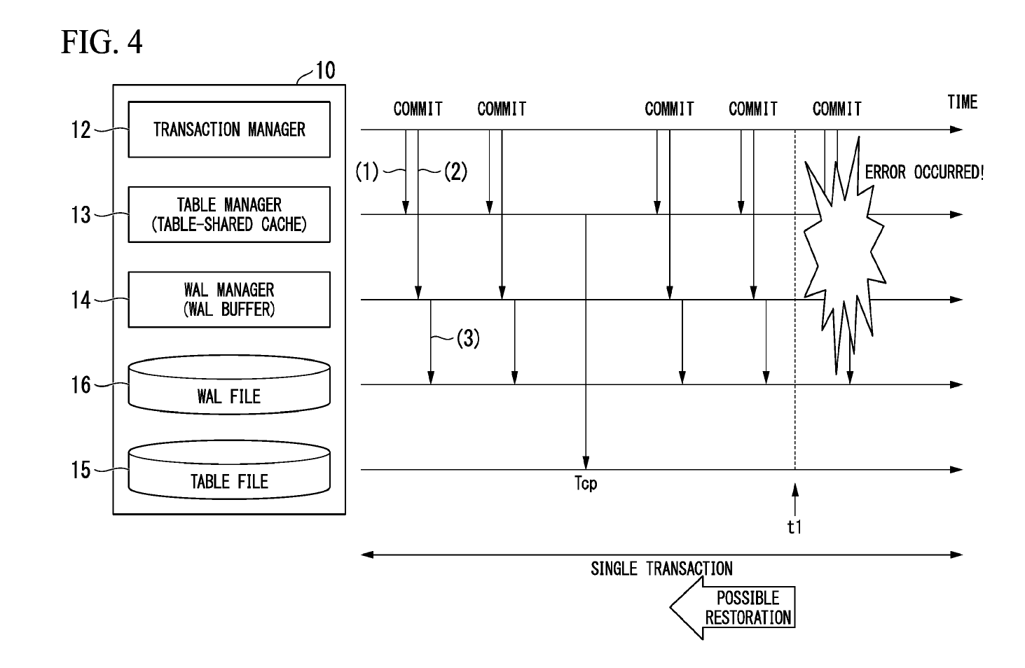

Here, FIG. 4 is a diagram illustrating a state of data restoration using WAL data. In the example of FIG. 4, the state of data restoration when an error (for example, data crash or power failure) has occurred in the above-described transaction process illustrated in FIG. 3 will be described. For example, if a write process based on the WAL mode has been executed, even if an error occurs during execution of the transaction as illustrated in FIG. 4, data at a point in time at which the last COMMIT was completed is stored in the WAL file 16. Thus, the database management device 10 can restore data to a state at the time indicated by t1 immediately before the error occurrence and after the checkpoint time Tcp using data of the WAL file 16. This technique is generally referred to as a roll forward technique.

Here, existing functions capable of selecting use of the WAL mode in the database system are, for example, “PostgreSQL,” “SQLite,” and the like. In the case of “PostgreSQL,” it is possible to create an UNLOGGED table that does not use WAL. However, it is necessary to specify whether or not to use the WAL mode when the table is created. Also, in the case of “SQLite,” in, for example, “PRAGMA journal_mode=WAL” command, it is possible to perform switching of the WAL mode in the entire database. In the above-described example, switching between “UNLOGGED” for which the WAL mode is unused at the time of writing data and “LOGGED” for which the WAL mode is used is selected in units of databases or in units of tables. Thus, convenience is not conventionally sufficient because the mode is shared by all clients connected to the database.

Therefore, in the first embodiment, because it is possible to properly use the WAL mode according to, for example, an importance level of data or the like, and execute transactions in parallel by controlling the use or nonuse of the above-described WAL in units of transactions, it is possible to speed up the transaction process. Therefore, the convenience of the database can be improved.

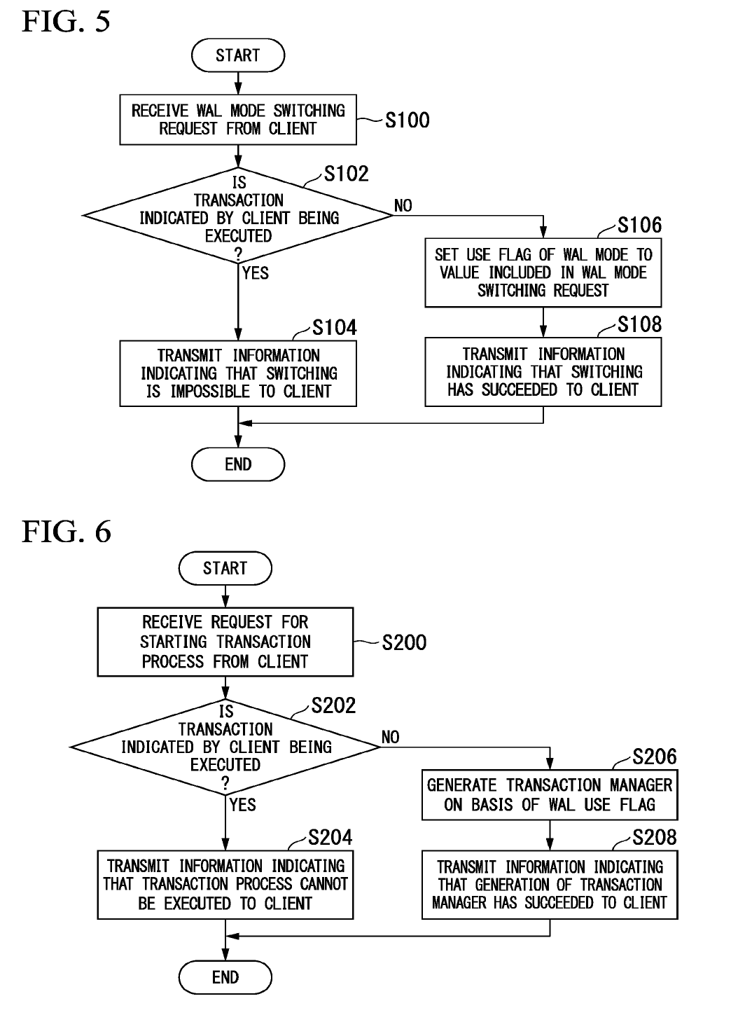

FIG. 5 is a flowchart illustrating an example of a WAL mode switching process in the first embodiment. In the example of FIG. 5, the front end processor 11 receives a request for switching the WAL mode from the client 20 (step S100). Next, the front end processor 11 refers to the transaction manager 12 and determines whether or not the transaction indicated by the client 20 is being executed (step S102). If the transaction indicated by the client 20 is being executed, the front end processor 11 transmits information indicating that the switching is impossible to the client without switching the WAL mode (step S104). This makes it possible to prevent switching of the WAL mode during one transaction process.

Also, if the transaction indicated by the client 20 is not being executed, the front end processor 11 sets the use flag of the WAL mode to a value included in the WAL mode switching request (step S106), and transmits information indicating that the setting has succeeded to the client 20 (step S108). Thereby, the process of the above-described present flowchart is completed.

FIG. 6 is a flowchart illustrating an example of a transaction start process in the first embodiment. In the example of FIG. 6, the front end processor 11 receives a request for starting a transaction process from the client 20 (step S200). Next, the front end processor 11 determines whether or not the transaction indicated by the client 20 is being executed (step S202).

If the transaction indicated by the client 20 is being executed, the front end processor 11 transmits information indicating that the transaction process cannot be executed to the client 20 (step S204).

Also, if the transaction indicated by the client 20 is not being executed, the front end processor 11 generates the transaction manager 12 on the basis of the WAL use flag (step S206), and transmits information indicating that the generation of the transaction manager 12 has succeeded to the client 20 (step S208). Thereby, the process of the above-described present flowchart is completed.

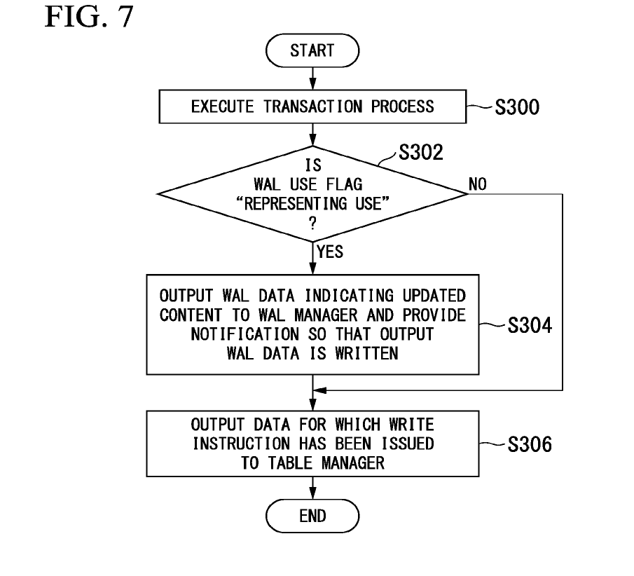

FIG. 7 is a flowchart illustrating an example of a process of writing WAL data in the first embodiment. In the example of FIG. 7, the transaction manager 12 executes a transaction process on the basis of an instruction from the front end processor 11 (step S300). At this time, the transaction manager 12 determines whether or not the WAL use flag indicated by the front end processor 11 is “representing use” (step S302).

If the WAL use flag is set to be “representing use,” the transaction manager 12 outputs WAL data indicating updated content to the WAL manager 14, and notifies the WAL manager 14 so that the output WAL data is written (step S304). Next, the transaction manager 12 outputs data for which a write instruction has been issued to the table manager 13 (step S306). If the WAL use flag is “representing non-use” in the above-described step S302, the transaction manager 12 outputs the data for which the write instruction has been issued to the table manager 13 without outputting the WAL data to the WAL manager 14 or notifying that the WAL data is to be written.

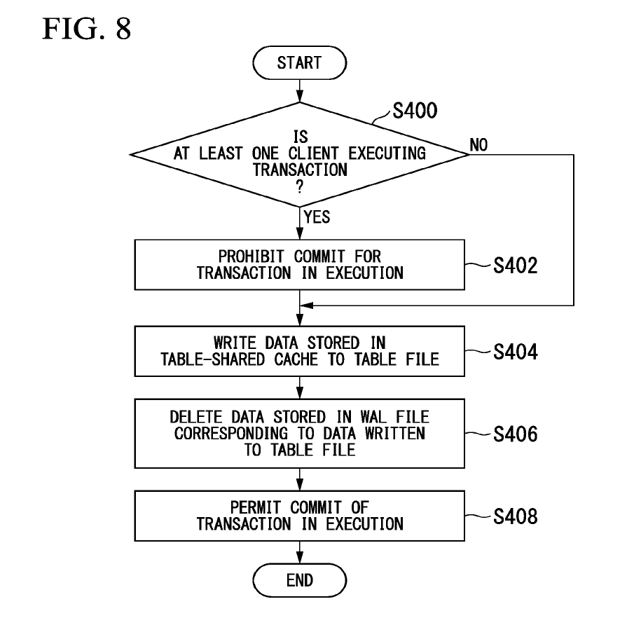

Next, the process of writing data to the table file 15 at the above-described checkpoint will be described with reference to the drawings. FIG. 8 is a flowchart illustrating an example of a write process on a table file in the first embodiment. In the example of FIG. 8, the table manager 13 determines whether or not at least one client 20 is executing a transaction (step S400). If the transaction is being executed, the table manager 13 prohibits COMMIT for the transaction in execution (step S402). Here, “prohibiting COMMIT” means, for example, prohibiting the confirmation of the result of a transaction currently being processed.

After the above-described processing of step S402 or if at least one client is not executing a transaction, the table manager 13 writes data stored in the table-shared cache to the table file 15 (step S404). Next, after the writing to the table file 15 is completed, the WAL manager 14 deletes data (WAL data) stored in the WAL file 16 according to an instruction from the table manager 13 or the like (step S406). The data to be deleted is the WAL data corresponding to the data written in the table file 15. Thereby, it is possible to prevent unnecessary data from being stored in the WAL file 16.

Next, if COMMIT for the transaction in execution is prohibited in the above-described processing of step S402, the transaction manager 12 permits COMMIT of the transaction in execution (step S408). Thereby, the process of the present flowchart is completed.

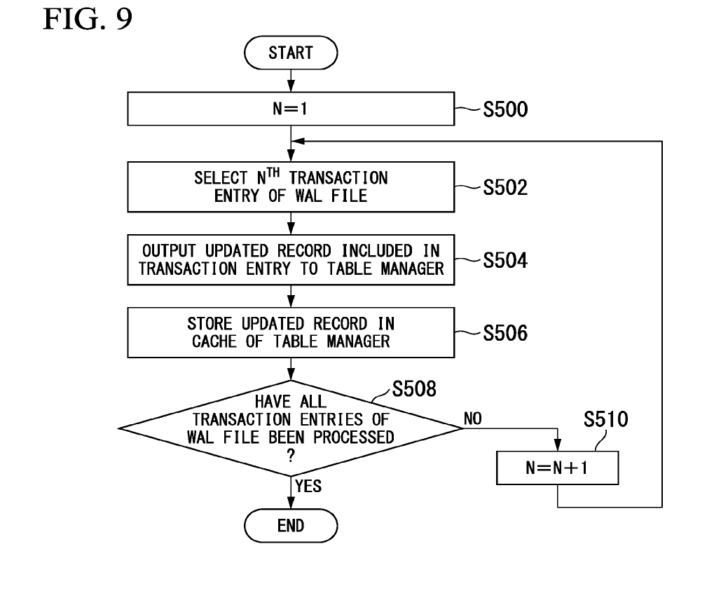

Next, the data restoration process of the database management device 10 at the time of occurrence of a malfunction in the database will be described with reference to the drawings. FIG. 9 is a flowchart illustrating an example of a restoration process in the first embodiment. In the example of FIG. 9, the WAL manager 14 sets a variable N to an initial value of 1 (N=1) (step S500) and selects an N^{th} transaction entry of the WAL file 16 (step S502). Here, the transaction entry is one or more records updated in one transaction. The transaction entry is included in the WAL data stored in the WAL file 16, and is data in which one or more updated records are associated with one header.

Next, the WAL manager 14 outputs the updated record included in the transaction entry to the table manager 13 (step S504), and stores the updated record in a cache (table-shared cache) of the table manager 13 (step S506).

Next, the WAL manager 14 determines whether or not all the transaction entries of the WAL file 16 have been processed (step S508). If not all the transaction entries have been processed, the WAL manager 14 increments the variable N by 1 (N=N+1) (step S510) and returns to the processing of step S502. If all the transaction entries of the WAL file 16 have been processed, the process of the present flowchart is completed.

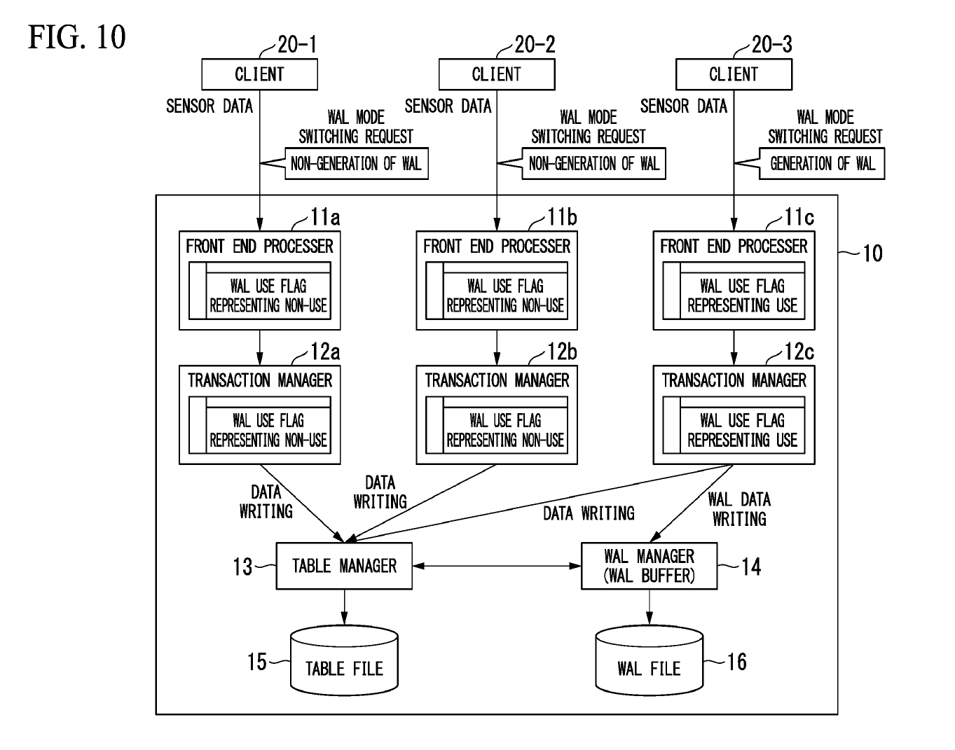

Next, a first example of a data write process in the first embodiment will be described with reference to the drawings. FIG. 10 is a diagram illustrating a first example of a write process in the first embodiment. In the first example, a mode is properly used according to an importance level of data stored in the database (the table file 15).

In the example of FIG. 10, clients 20-1 to 20-3 are provided. Each of the clients 20-1 to 20-3 includes a sensor that detects predetermined information. The clients 20-1 to 20-3 generate sensor data capable of being accumulated as a database from the detection results obtained from each sensor, and output the generated sensor data to the database management device 10.

Here, in the first embodiment, if a large amount of sensor data is stored in the table file 15, it is properly determined whether or not to use WAL according to the importance level of the data. For example, important data is written using WAL, and other data is written without using WAL. Thereby, important data can be guaranteed, and the throughput of writing can be increased as compared with when WAL is used for writing all data.

For example, it is assumed that the importance level of data obtained from the clients 20-1 and 20-2 illustrated in FIG. 10 is low and the importance level of data obtained from the client 20-3 is high. In this case, the clients 20-1 and 20-2 transmit a WAL mode switching request without using WAL to the database management device 10. Also, the client 20-3 transmits the WAL mode switching request using WAL to the database management device 10. Also, the mode without using WAL corresponds to the above-described UNLOGGED mode and the mode using WAL corresponds to the above-described LOGGED mode.

Also, the proper use of the WAL mode is not limited to the above example. For example, the importance level may be set according to the time interval for acquiring the detection result from the sensor, and the switching of the WAL mode may be performed according to the set importance level. For example, if the sensor detection result is acquired every second, the client 20 switches the mode so that the sensor data is written in the UNLOGGED mode. Also, if the detection result of the sensor is acquired every 5 seconds, the client 20 switches the mode so that the sensor data is written in the LOGGED mode.

Also, in the example of FIG. 10, the database management device 10 includes front end processors 11a to 11c corresponding to transaction processes from the clients 20-1 to 20-3. The front end processors 11a to 11c generate transaction managers 12a to 12c corresponding to the transactions and manage the presence or absence of writing of WAL data to the generated transaction manager 12 according to the WAL use flag. In the example of FIG. 10, the transaction manager 12c outputs WAL data of sensor data having a high importance level for which a write instruction is issued from the client 20-3 to the WAL manager 14, and outputs the sensor data to be written to the table manager 13. The transaction managers 12a and 12b output sensor data having a low importance level (having an importance level which is not high) for which the write instructions are issued from the clients 20-1 and 20-2 to the table manager 13. The table manager 13 writes the sensor data to the table file 15 in a predetermined period (a period of a checkpoint).

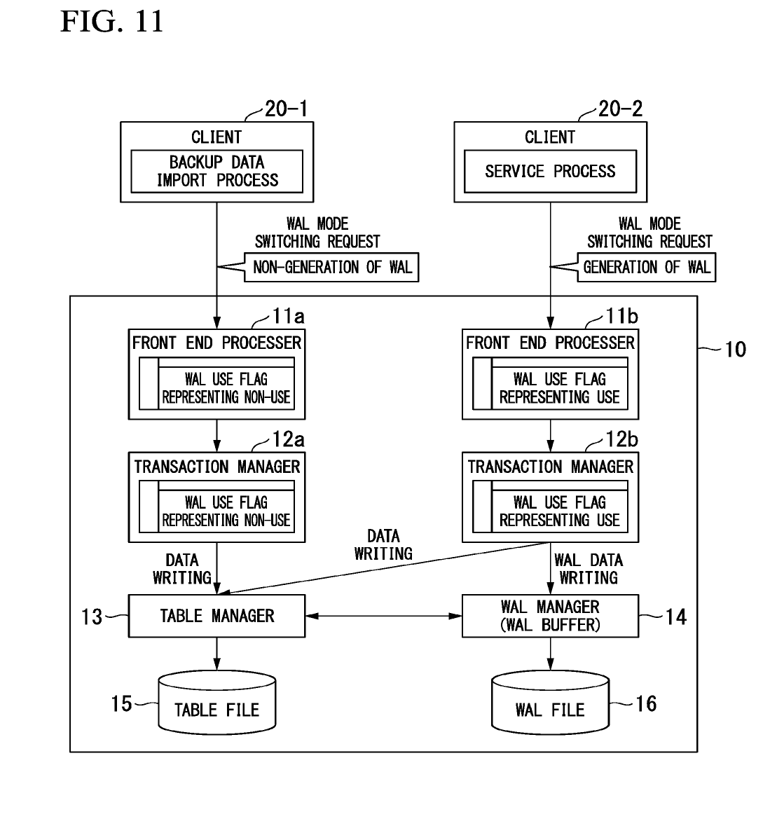

Next, a second example of the data write process in the first embodiment will be described with reference to the drawings. FIG. 11 is a diagram illustrating the second example of a write process in the first embodiment. In the second example, a case in which a service (for example, a data collection service) is started while backup data is imported in system restoration is shown. In the example of FIG. 11, a client 20-1 having a backup data import process and a client 20-2 having a service process are provided. Each process is executed by a module, a program, or the like. Each of the clients 20-1 and 20-2 performs a setting (a switching request) of the WAL mode according to a transaction of a write process to be executed in each process. Also, the database management device 10 illustrated in FIG. 11 includes front end processors 11a and 11b and transaction managers 11a and 12b corresponding to transactions. On the basis of the WAL use flag indicated from the clients 20-1 and 20-2, the transaction manager 12 imports the backup data to the table file 15 and starts a service.

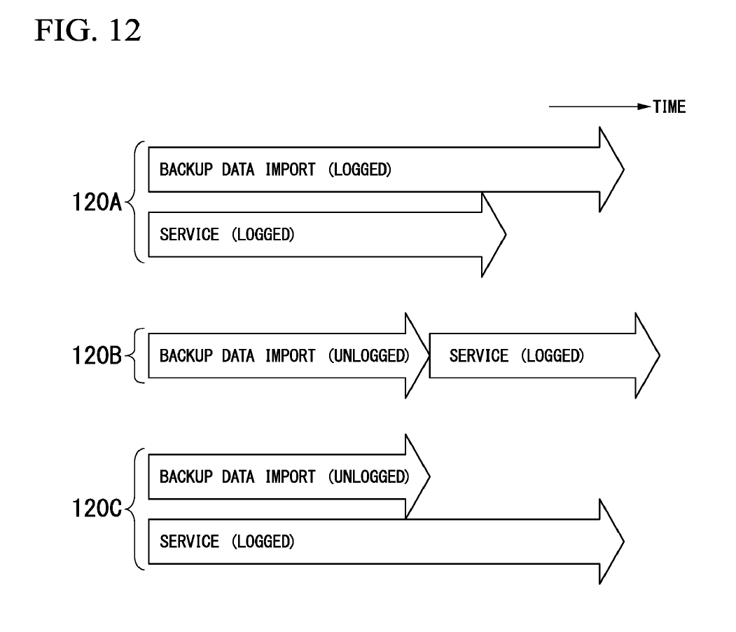

Here, FIG. 12 is a diagram illustrating a flow of a process according to a service start timing. The diagrams indicated by 120A and 120B illustrate the flow of the process according to the service start timing in the conventional technique, and the diagram indicated by 120C illustrates the flow of the process based on the service start timing in the second example.

For example, if all transaction processes in backup data import and service processes are in the LOGGED mode (a mode using WAL) in the conventional technique, the completion of the import is delayed as illustrated in the diagram indicated by 120A due to an influence of a process of writing WAL data because an amount of backup data is enormous if the backup data import process and the service process are started at the same time.

Also, if the backup data import is processed in the UNLOGGED mode (a mode in which WAL is not used) and the transaction process in the service process is executed in the LOGGED mode in the conventional technique, the service process needs to be executed at a point in time at which the import of the backup data is completed as illustrated in the diagram indicated by 120B because it is necessary to switch the mode for each database or table. Therefore, the start of service is delayed.

On the other hand, because it is possible to switch the LOGGED mode or the UNLOGGED mode for each transaction in the second example, the service can be started in the LOGGED mode in parallel with the transaction while the backup data is imported in the UNLOGGED mode as illustrated in the diagram indicated by 120C. Thus, because the service can be started at an earlier timing and data after the start of the service is also guaranteed according to the second example, restoration up to immediately previous data is possible even if a failure such as a power failure occurs.

As described above, in the first embodiment, convenience can be improved because it is possible to control the use or nonuse of WAL in units of transactions by setting whether or not to use WAL for each transaction indicated from the client 20. Also, according to the first embodiment, for example, it is possible to properly use the WAL mode according to an importance level of data and speed up the transaction of a write process on the database. Also, because it is possible to start the service while importing backup data, a downtime can be reduced.

### Second Embodiment

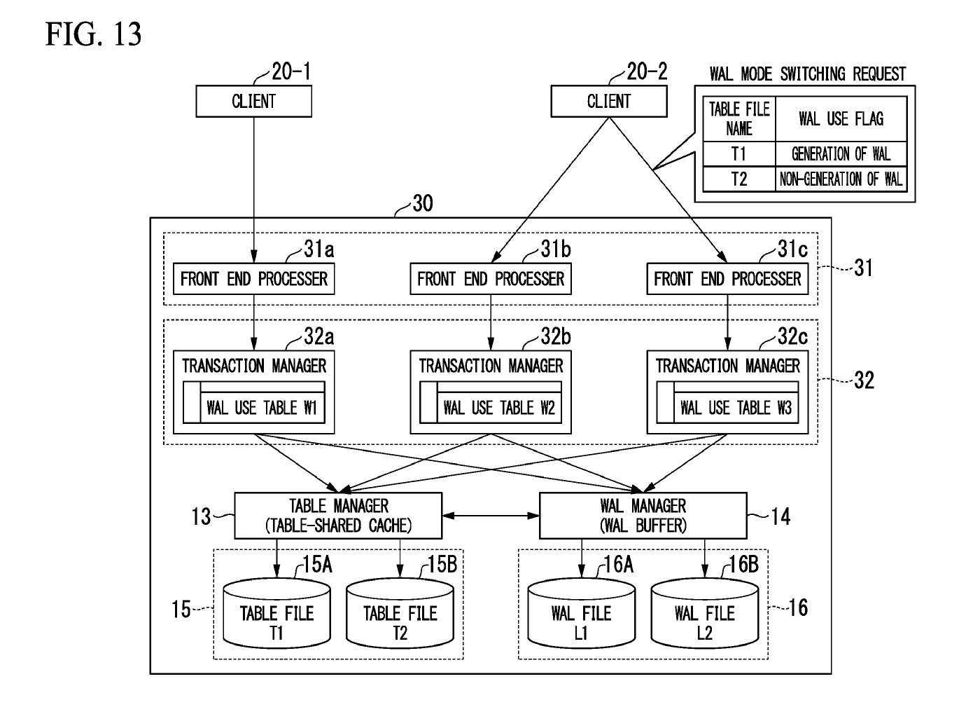

Next, the second embodiment of the database management device will be described with reference to the drawings. FIG. 13 is a diagram illustrating an example of a functional configuration of the database management device in the second embodiment. Also, in a database management device 30 illustrated in FIG. 13, similar reference signs are given to constituent parts that perform a process similar to that of the database management device 10 in the above-described first embodiment, and specific description here is omitted.

The database management device 30 illustrated in FIG. 13 includes a front end processor (determiner) 31, a transaction manager 32, a table manager 13, a WAL manager 14, a table file 15, and a WAL file 16. Also, two clients (clients 20-1 and 20-2) are shown as clients 20 using the database management device 30 in the example of FIG. 13, but the number of clients is not limited thereto. In the example of FIG. 13, the write process by one transaction is executed from the client 20-1 and the write process by the two transactions is executed from the client 20-2. In the example of FIG. 13, front end processors 31a to 31c for executing transactions are provided, and transaction managers 32a to 32c generated in correspondence with the front end processors 31a to 31c are provided.

In the second embodiment, whether or not to use WAL for each table file to which data is written in each transaction is set as a WAL mode switching request to be transmitted from the client 20 to the database management device 30. The transaction managers 32a to 32c include WAL use tables W1 to W3 in which information indicating whether or not to use WAL is stored for each target table file to which data is written in each transaction process.

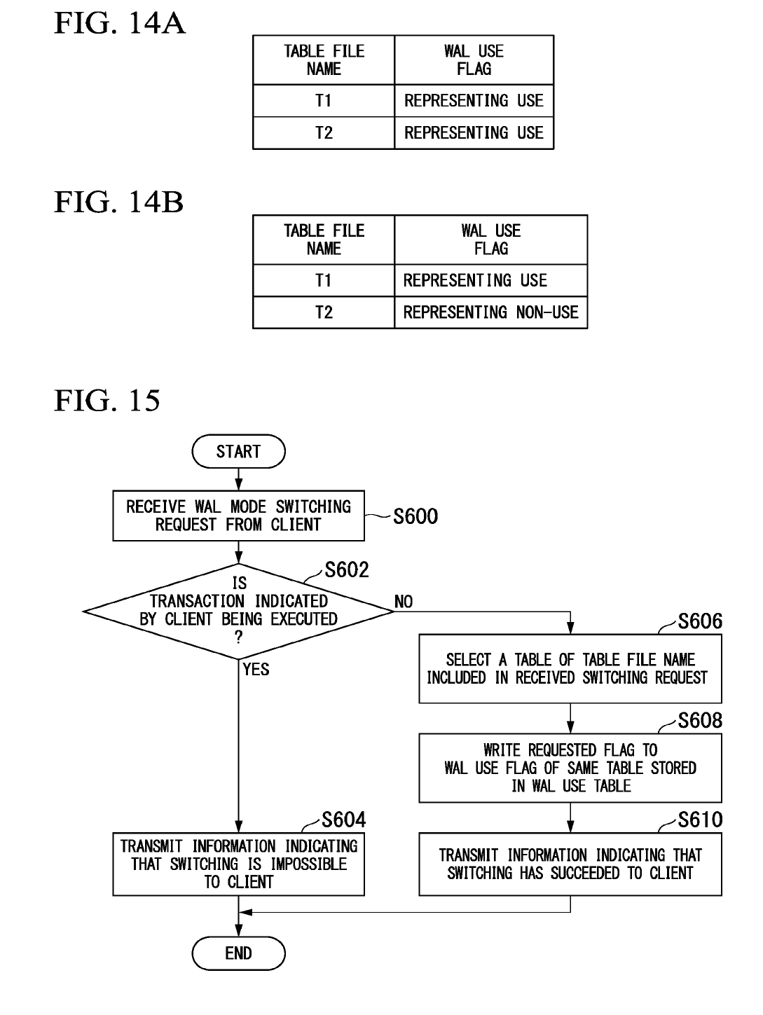

FIGS. 14A and 14B are diagrams illustrating an example of a WAL use table provided in the transaction manager 32. FIG. 14A illustrates the WAL use tables W1 and W2 provided in the transaction managers 32a and 32b illustrated in FIG. 13, and FIG. 14B illustrates the WAL use table W3 provided in the transaction manager 32c illustrated in FIG. 13. Items of the WAL use table are, for example, a “table file name,” a “WAL use flag,” and the like. In the WAL use table, information about the use/nonuse of the WAL mode is set for each write target table file in each transaction.

Here, in the second embodiment, the write process using WAL is assumed to be performed as the initial setting of the WAL use table. Therefore, if the WAL mode switching request has not been transmitted from the client 20, the WAL use flags of the table files T1 15A and T2 15B are set to be “representing use” in the WAL use tables W1 to W3 as illustrated in FIG. 14A. Also, the initial setting is not limited thereto, and, for example, the initial setting may be performed so that the write process is performed without using WAL.

If the WAL mode switching request has been received from the client 20, the front end processor 31 instructs the transaction manager 32 to update the WAL use table. The transaction manager 32 updates the WAL use table based on the WAL mode switching request on the basis of the instruction from the front end processor 31 and executes a transaction process including writing of data using the updated use table.

In the example of FIG. 13, the client 20-2 issues a WAL mode switching request for each write target table (table file) in the transaction to be executed. For example, if data is written to the table files T1 and T2 in a transaction managed by the transaction manager 32c, the client 20-2 outputs a switching request so that writing of data using WAL to the table file T1 is performed and writing of data without using WAL to the table file T2 is performed. Also, the client 20 has information about a table file 15 to be used for each execution instruction transaction. Thus, the client 20 can set whether or not to use WAL for each table file used in each transaction.

Also, in the above-described example, whether or not to use the WAL mode is set for each table file used in the write process. However, for example, a request for switching only a table file (for example, the table file T2 illustrated in FIG. 13) for switching the WAL mode may be output. On the basis of the indicated switching request, the transaction manager 32c updates the WAL use table W3 to content illustrated in FIG. 14B.

Thereby, the transaction manager 32a and the transaction manager 32b output written data to the table manager 13 on the basis of information of the WAL use table illustrated in FIG. 14A, and output WAL data to the WAL manager 14. Also, if data is written to the table files T1 and T2 in the transaction to be executed, the transaction manager 32c performs the write process based on the updated WAL use table W3. Specifically, if data is written to the table file T1, the transaction manager 32c outputs the written data to the table manager 13, outputs the WAL data to the WAL manager 14, and writes the output WAL data to the WAL file 16. Also, if the data is written to the table file T2, the transaction manager 32c outputs the written data only to the table manager 13.

FIG. 15 is a flowchart illustrating an example of a WAL mode switching process in the second embodiment. In the example of FIG. 15, the front end processor 31 receives a WAL mode switching request from the client 20 (step S600), and determines whether or not a transaction indicated by the client is being executed (step S602). If the transaction indicated by the client 20 is being executed, the front end processor 31 outputs information indicating that switching is impossible for the transaction in execution to the client 20 (step S604).

Also, if the transaction indicated by the client 20 is not being executed, the transaction manager 32 selects a table of the table file name included in the received switching request (step S606) and writes a requested flag to a WAL use flag of the same table stored in the WAL use table (step S608).

Next, the front end processor 31 transmits information indicating that the switching has succeeded to the client 20 (step S610). Thereby, the process of the present flowchart is completed.

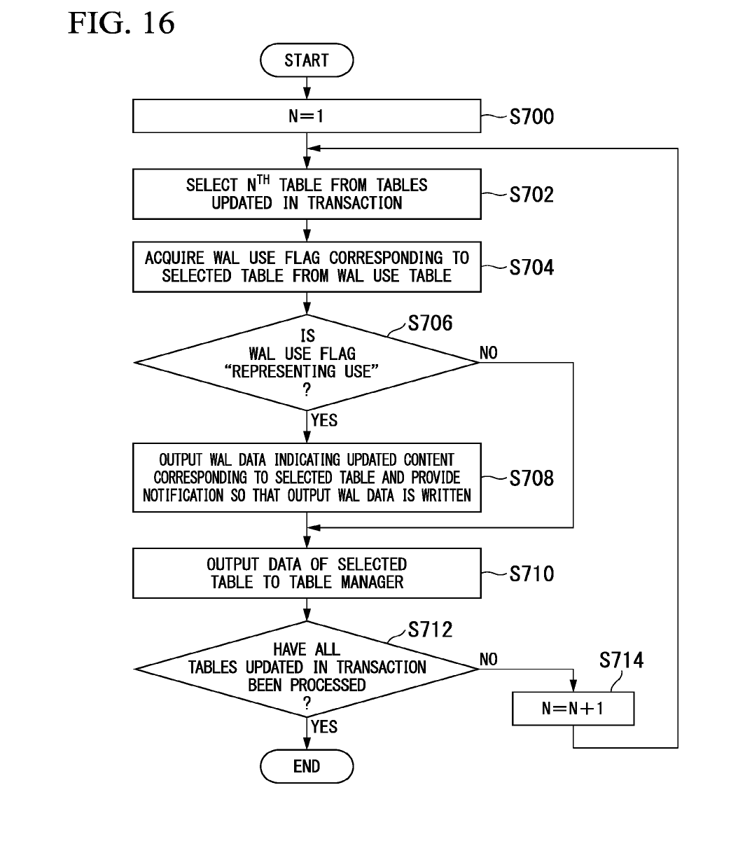

FIG. 16 is a flowchart illustrating an example of a process of writing WAL data in the second embodiment. In the example of FIG. 16, the transaction manager 32 sets the variable N to an initial value of 1 (N=1) (step S700) and selects an N^{th} table from the table updated in the transaction (step S702).

Next, the transaction manager 32 acquires the WAL use flag corresponding to the selected table from the WAL use table (step S704) and determines whether or not the WAL use flag of the selected table is “representing use” from the acquired use flag (step S706).

When the WAL use flag is set to be “representing use,” the transaction manager 32 outputs WAL data indicating updated content corresponding to the selected table and notifies the WAL manager 14 so that the output WAL data is written (step S708) After the processing of step S708 or if the WAL use flag is not set to be “representing use,” the transaction manager 32 outputs the data of the selected table to the table manager 13 (step S710).

Next, the transaction manager 32 determines whether or not all the tables updated by the transaction have been processed (step S712). If not all the tables have been processed, the variable N is incremented by 1 (N=N+1) (step S714) and the process returns to the processing of step S702. When all the tables have been processed, the process of the present flowchart is completed.

Also, because a write process on the table file 15 in the table manager 13 at a checkpoint time and a data restoration process at a failure occurrence time in the second embodiment are the same as those in the above-described first embodiment, specific description here will be omitted.

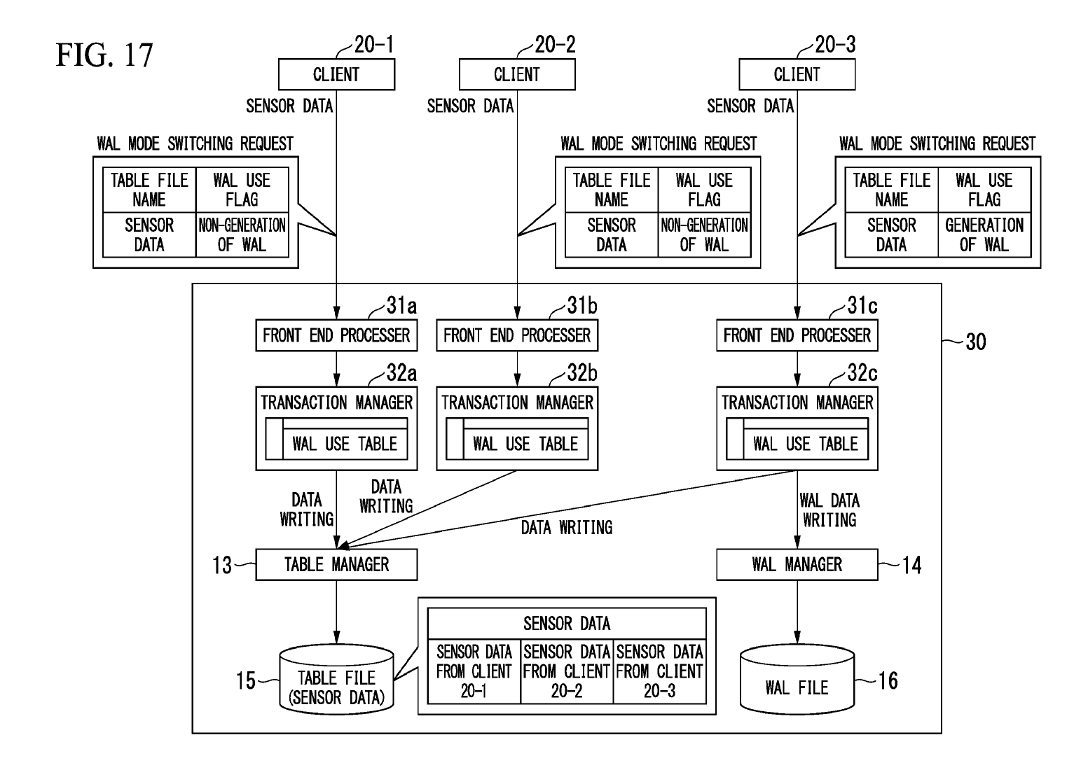

Next, the first example of the write process in the second embodiment will be described with reference to the drawings. FIG. 17 is a diagram illustrating a first example of a write process in the second embodiment. In the first example, a mode is properly used according to an importance level of data stored in the database (the table file 15).

In the first example illustrated in FIG. 17, as in FIG. 10 described above, clients 20-1 to 20-3 are provided and each of the clients 20-1 to 20-3 includes a sensor that detects predetermined information. The clients 20-1 to 20-3 output sensor data obtained from sensors to the database management device 30.

Here, in the first embodiment, if a large amount of sensor data is stored in the table file 15, it is properly determined whether or not to use WAL for each table file used in each transaction according to the importance level of the data. For example, important data is written using WAL and other data is written without using WAL.

Also, in the example of FIG. 17, the database management device 30 includes front end processors 31a to 31c corresponding to transaction processes from the clients 20-1 to 20-3. The front end processors 31a to 31c create the transaction managers 32a to 32c corresponding to the transactions and manage the presence or absence of writing the WAL data to the generated transaction manager 32 according to the WAL use flag. In the example of FIG. 17, the transaction manager 32c outputs WAL data of sensor data having a high importance level for which a write instruction is issued from the client 20-3 to the WAL manager 14, and also outputs the sensor data to be written to the table manager 13. The transaction managers 32a and 32b output sensor data having a low importance level (an importance level which is not high) for which the write instruction is issued from the clients 20-1 and 20-2 to the table manager 13. The table manager 13 writes the sensor data to the table file 15 in a predetermined period (a period of a checkpoint). In this case, as illustrated in FIG. 17, in the table file (sensor data) 15, sensor data from each of the clients 20-1 to 20-3 is stored as a table. At this time, only the sensor data from the client 20-3 is guaranteed by the WAL data. Thereby, important data can be guaranteed and the throughput of writing can be increased as compared with when the WAL mode is used for writing all data.

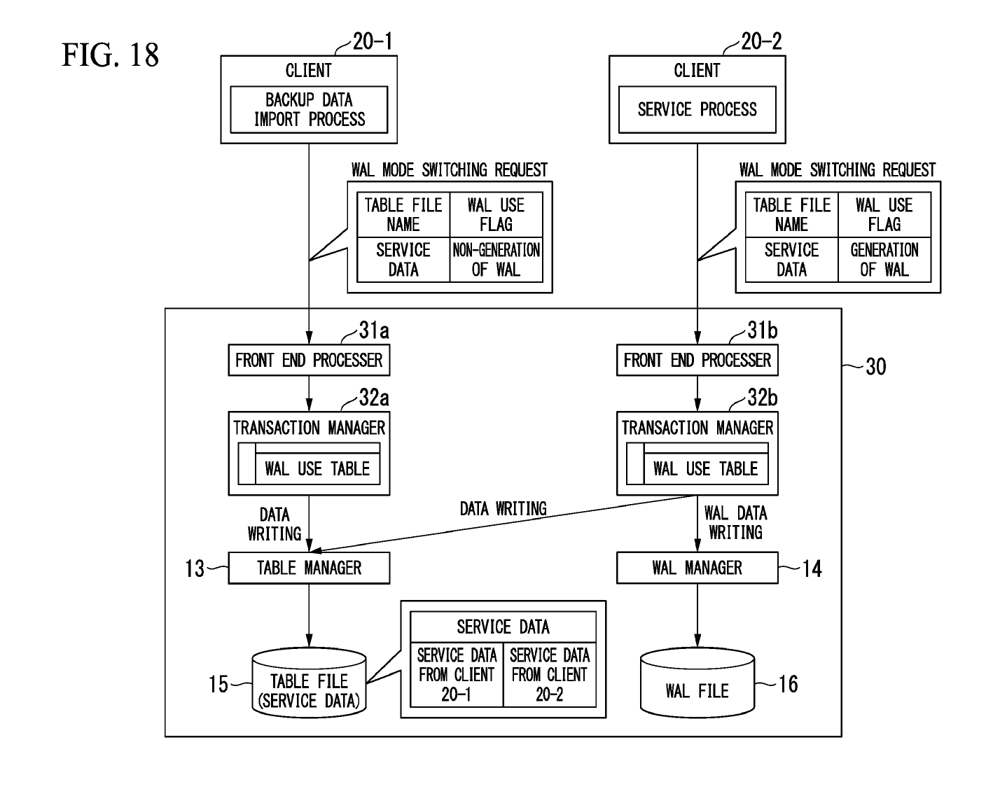

Next, a second example of the data write process in the second embodiment will be described with reference to the drawings. FIG. 18 is a diagram illustrating the second example of the write process in the second embodiment. In the second example, as in FIG. 11 described above, the case in which the service is started during the import of the backup data in the system restoration is shown in the second example. In the example of FIG. 18, a client 20-1 having a backup data import process and a client 20-2 having a service process are provided. Each of the clients 20-1 and 20-2 performs a WAL mode setting (switching request) according to a transaction of a write process to be executed in each process.

Also, the database management device 30 illustrated in FIG. 18 includes front end processor units 31a and 31b corresponding to each transaction and transaction managers 32a and 32b. The transaction manager 32 imports backup data to the table file 15 and starts a service on the basis of a WAL use flag for each of tables indicated from the clients 20-1 and 20-2.

Specifically, in the example of FIG. 18, the transaction manager 32a outputs service data for which a write instruction is issued from the client 20-1 to the table manager 13. Also, the transaction manager 32b outputs WAL data of the service data for which a write instruction is issued from the client 20-2 to the WAL manager 14 and outputs the service data to be written to the table manager 13. The table manager 13 writes the service data to the table file 15 in a predetermined period (a period of a checkpoint). In this case, as illustrated in FIG. 18, in the table file (service data) 15, service data from each of the clients 20-1 and 20-2 is stored as a table. At this time, only the service data from the client 20-2 is guaranteed by the WAL data.

As described above, in the second embodiment, by setting whether or not to use WAL for each table to which data is written by each transaction indicated from the client 20, it is possible to further improve the convenience because the use or nonuse of the WAL can be controlled in units of data of each transaction. Also, according to the second embodiment, for example, it is possible to speed up the proper use of the WAL mode according to an importance level of data and the transaction of a write process on the database. Also, because it is possible to start the service while importing backup data, a downtime can be reduced.

According to at least one embodiment described above, a front end processor (a determiner) that determines whether or not to write WAL data for each transaction process corresponding to a write instruction and a transaction manager that causes the table manager to write data and causes the WAL manager to write WAL data if it is determined that WAL data is written and causes the table manager to write data if it is determined that WAL data is not written are provided and therefore it is possible to improve convenience.

More specifically, for example, because the WAL mode is properly used according to an importance level of data or only the WAL data of the necessary data is written to the WAL file, it is possible to speed up a transaction of a write process to a database more than when WAL data is generated for all the data and written to the WAL file. Also, because it is possible to start the service while importing backup data, a downtime can be reduced.

Above mentioned embodiments may be described as follows.

[1] A database management system including:

a software component; and

a hardware processor configured to execute the software component to implement:

a first write manager configured to write data for which a write instruction has been issued from a client to an address corresponding to a logical address indicated by the client in a first storage area of a storage unit;

a second write manager configured to write ahead logging (WAL) data corresponding to the write instruction from the client to any address in a second storage area of the storage unit;

a determiner configured to determine whether or not to write the WAL data to the second storage area for each transaction process corresponding to the write instruction on the basis of information indicated from the client; and

a transaction manager configured to cause the first write manager to write the data and cause the second write manager to write the WAL data if the determiner determines to write the WAL data, and cause the first write manager to write the data if the determiner determines not to write the WAL data, on the basis of the instruction from the client.

[2] A database management system including:

circuitry configured to implement:

a first write manager configured to write data for which a write instruction has been issued from a client to an address corresponding to a logical address indicated by the client in a first storage area of a storage unit;

a second write manager configured to write ahead logging (WAL) data corresponding to the write instruction from the client to any address in a second storage area of the storage unit;

a determiner configured to determine whether or not to write the WAL data to the second storage area for each transaction process corresponding to the write instruction on the basis of information indicated from the client; and

a transaction manager configured to cause the first write manager to write the data and cause the second write manager to write the WAL data if the determiner determines to write the WAL data, and cause the first write manager to write the data if the determiner determines not to write the WAL data, on the basis of the instruction from the client.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A database management device comprising:
a first write manager configured to write data for which a write instruction has been issued from a client to an address corresponding to a logical address indicated by the client in a first storage area of a storage unit;
a second write manager configured to write ahead logging (WAL) data corresponding to the write instruction from the client to any address in a second storage area of the storage unit;
a determiner configured to determine whether or not to write the WAL data to the second storage area for each transaction process corresponding to the write instruction on the basis of information indicated from the client; and
a transaction manager configured to cause the first write manager to write the data and cause the second write manager to write the WAL data if the determiner determines to write the WAL data, and cause the first write manager to write the data if the determiner determines not to write the WAL data, on the basis of the instruction from the client.

2. The database management device according to claim 1, wherein the transaction process is a process in which a plurality of write processes indicated from the client are executed as a set of processes.

3. The database management device according to claim 1, wherein the second write manager sequentially writes the WAL data to a physical address of the second storage area.

4. The database management device according to claim 1, wherein the determiner determines whether or not to cause the second write manager to write the WAL data on the basis of a request for switching a write mode indicated from the client.

5. The database management device according to claim 4,
wherein the write mode includes a write mode for each table stored in the first storage area to which data is written according to the transaction process, and
wherein the determiner determines whether or not to store the WAL data in the second storage area for each table on the basis of a request for switching the write mode indicated from the client.

6. A database management method comprising:
writing, by a computer of a database management device, data for which a write instruction has been issued from a client to an address corresponding to a logical address indicated by the client in a first storage area of a storage unit using a first write manager;
writing, by the computer of the database management device, WAL data corresponding to the write instruction from the client to any address in a second storage area of the storage unit using a second write manager;
determining, by the computer of the database management device, whether or not to write the WAL data to the second storage area for each transaction process corresponding to the write instruction on the basis of information indicated from the client; and
causing, by the computer of the database management device, the first write manager to write the data and causing the second write manager to write the WAL data if the WAL data is determined to be written, and causing the first write manager to write the data if the WAL data is determined not to be written, on the basis of the instruction from the client.

7. A non-transitory computer-readable storage medium storing a computer program, which when executed by a database management device, causes the database management device to perform
writing data for which a write instruction has been issued from a client to an address corresponding to a logical address indicated by the client in a first storage area of a storage unit using a first write manager;
writing WAL data corresponding to the write instruction from the client to any address in a second storage area of the storage unit using a second write manager;
determining whether or not to write the WAL data to the second storage area for each transaction process corresponding to the write instruction on the basis of information indicated from the client; and
causing the first write manager to write the data and cause the second write manager to write the WAL data if the WAL data is determined to be written, and causing the first write manager to write the data if the WAL data is determined not to be written, on the basis of the instruction from the client.
